(19) United States
(12) Patent Application Publication
(10) Pub. No.: US 2017/0008778 A1
(43) Pub. Date: Jan. 12, 2017

(54) FREEZING DESALINATION MODULE

(71) Applicant: KING ABDULAZIZ UNIVERSITY, Jeddah (SA)

(72) Inventors: SAMIR ELSAYED ALY, JEDDAH (SA); MOHAMMED HUSSAIN AL-BEIRUTTY, JEDDAH (SA); SALAH AL-TAHAR BOUGUECHA, JEDDAH (SA)

(21) Appl. No.: 14/794,674

(22) Filed: Jul. 8, 2015

(51) Int. Cl. C02F 1/26; B01D 9/04; C02F 1/22

(52) U.S. Cl. CPC C02F 1/265; C02F 1/22; B01D 9/04

(57) ABSTRACT

The freezing desalination module includes a pair of desalination units coupled to a pair of refrigeration units. A pre-cooling tank and a freezing tank is disposed in each desalination unit. A feed line, a desalinated line, and a brine line are coupled to the freezing desalination module to respectively enable feeding of raw feed water (RFW) through the module, collect desalinated water, and remove brine/ice wash for further processing. The RFW in the pre-cooling tank is pre-cooled by a pair of heat exchangers, through which flows cooler desalinated water and the brine/ice wash, respectively. The freezing tank of both desalination units are in communication with the refrigeration units so that as one freezing tank performs freezing, the other is melting. A perforated plate divides each freezing tank into an upper chamber where freezing desalination process occurs and a lower chamber where brine/ice wash collect and feed through the pre-cooling tank.

### BACKGROUND OF THE INVENTION

### 1. Field of the Invention

The present invention relates to desalination systems, and particularly to a freezing desalination module that provides an efficient and highly configurable desalination solution for most applications.

### 2. Description of the Related Art

Among various technologies proposed for water desalination, freezing desalination technology has received the least attention. From a purely chemical point of view, impurities are naturally excluded from the ice crystal structures as they grow, since ice crystals will ideally be composed of pure water. Compared to other technologies, ice offers a number of advantages. For example, ice formation does not require sensitive components, such as membranes and high pressure pumps usually employed in various membrane-based water separation technologies. Moreover, it does not operate at high temperatures usually encountered in distillation-based water separation processes. As a thermal process, the specific energy requirement for freezing desalination is about one seventh of that required for the distillation processes. Other advantages also include immunity from fouling and scaling, in that only basic pretreatment is required, with minimal corrosion and metallurgical issues, and it permits using cheaper material for construction. Freezing desalination is also relatively insensitive to the type or concentration of polluting substances in the feed.

Despite the aforementioned advantages, the freezing desalination process suffers from some inherited problems that hinder its commercial application. Due to the nature of the process, it follows a set of discrete successive steps, e.g., freezing, washing, and melting. Accordingly, the process utilizes separate functional components, and the working fluid moves from one component to the other. Such an operational pattern is different than those normally encountered in other water separation processes. For example, the ice/brine slurry is usually pumped from a freezer to a washing column to remove the brine adhering to ice crystal surfaces, and the harvesting efficiency for the ice crystals is greatly affected by the size of the formed ice crystals. Thereafter, the washed ice has to be transported to a melting vessel, and then the melted ice is delivered as produced fresh water.

The process complexity, capital cost involved, together with up-scaling problems has prevented freezing desalination technology from being a market competitor. Moreover, the unsuitability of employing conventional refrigeration machines, especially for regions of hot climatic conditions with severe shortage of water, e.g., the Arabian Gulf countries, presents problems that hinder commercial development of freezing desalination technology.

Thus, a freezing desalination module solving the aforementioned problems is desired.

### SUMMARY OF THE INVENTION

The freezing desalination module includes a pair of desalination units coupled to a pair of refrigeration units. A pre-cooling tank and a freezing tank are disposed in each desalination unit. A feed line, a desalination line, and a brine line are coupled to the freezing desalination module to respectively enable feeding of raw feed water (RFW) through the module, collect desalinated water, and remove brine/ice wash for further processing. The RFW in the pre-cooling tank is pre-cooled by a pair of heat exchangers, through which flows cooler desalinated water and the brine/ice wash, respectively. The freezing tank of both desalination units is in communication with the refrigeration units so that as one freezing tank performs freezing, the other is melting. A perforated plate divides each freezing tank into an upper chamber where freezing desalination process occurs and a lower chamber where brine/ice wash collect and feed through the pre-cooling tank.

These and other features of the present invention will become readily apparent upon further review of the following specification and drawings.

### BRIEF DESCRIPTION OF THE DRAWINGS

FIG. 1 is a schematic diagram of a freezing desalination module according to the present invention.

FIG. 2 is a schematic diagram of a cycle of operation for the freezing desalination module of FIG. 1.

Similar reference characters denote corresponding features consistently throughout the attached drawings.

### DETAILED DESCRIPTION OF THE PREFERRED EMBODIMENTS

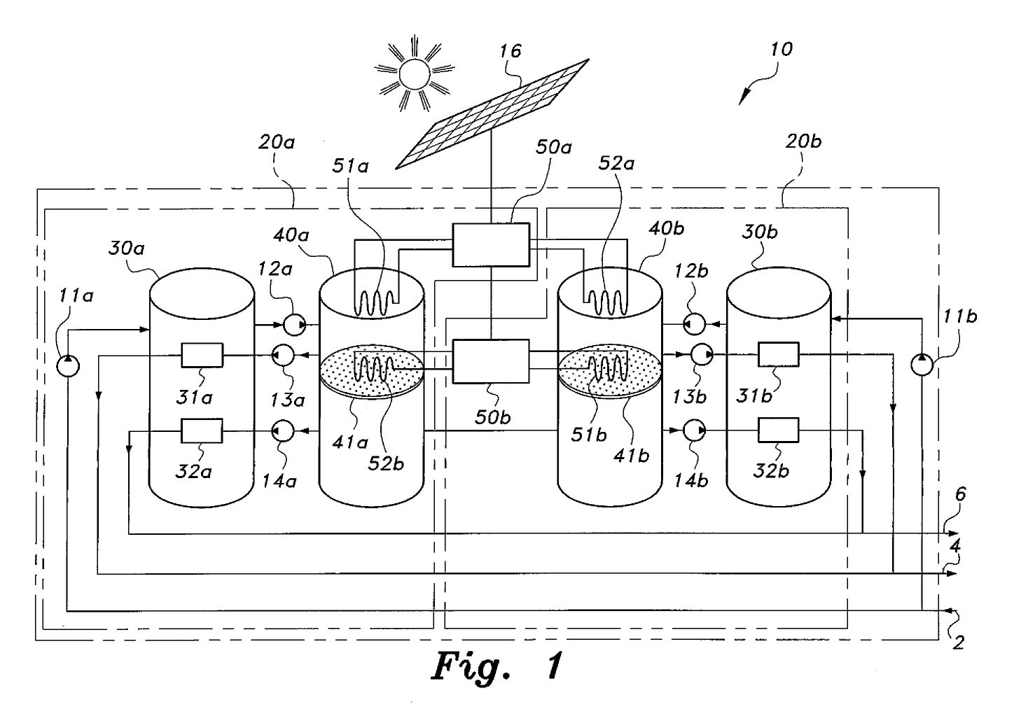

The freezing desalination module, generally referred to by the reference number 10 in the drawings, provides an efficient and highly configurable desalination solution for most applications. As best shown in FIG. 1, the freezing desalination module 10 includes a pair of desalination units 20a, 20b coupled to a pair of refrigeration units 50a, 50b.

The freezing desalination module 10 is coupled to a feed line 2 that feeds raw feed water (RFW), such as saltwater, through the freezing desalination module 10 to process the feed water into desalinated water. A desalination water line or outlet 4 extends from the freezing desalination module 10 to collect desalinated water for further processing. Wastewater from the desalination process, such as ice wash and brine from the desalination units 20a, 20b, is discharged through a brine line or outlet 6 that also extends from the freezing desalination module 10.

Each desalination unit 20a, 20b includes a first tank or pre-cooling tank 30a, 30b coupled to a second tank or freezing tank 40a, 40b. The capacity of each tank 30a, 30b, 40a, 40b is preferably equal. The RFW and the products of the desalination process, such as desalinated water, ice wash, and brine, are transferred between the tanks and the various lines by a plurality of pumps. These pumps include a first pump 11a, 11b coupled to the respective first tanks 30a, 30b to selectively and positively feed the RFW from the feed line 2 into the first tanks 20a, 20b. A second pump 12a, 12b feeds pre-cooled RFW from the first tank 30a, 30b to the second tank 40a, 40b, respectively. A third pump 13a, 13b transfers desalinated water from the second tank 40a, 40b through the first tank 30a, 30b, respectively, to aid in the pre-cooling process, and discharges through the desalinated line 4 for collection. A fourth pump 14a, 14b also aids in the pre-cooling process by passing brine and ice wash from the second tank 40a, 40b through the first tank 30a, 30b and into the brine line 6.

Each first tank 30a, 30b is provided with a first heat exchanger 31a, 31b and a second heat exchanger 32a, 32b, respectively, to enable pre-cooling the RFW contained therein. The products of the second tank, i.e., desalinated water, brine, and ice wash, are all at lowered temperatures due to their processing through the second tank 40a, 40b. The first tank 30a, 30b utilizes the lower temperature of these products to cool the RFW, to some extent. The desalinated water passes through the first heat exchanger 31a, 31b, while the brine and ice wash pass through the second heat exchanger 32a, 32b, each contributing to cooling the RFW.

All of the steps of ice formation, ice freezing, ice washing, and ice melting in a freezing desalination process to obtain desalinated water occur within each second tank 40a, 40b. Unlike most conventional freezing desalination systems, the second tank 40a, 40b does not require pumping of ice/brine nor ice transport between various functional components of the system. Each second tank 40a, 40b is divided into separate chambers, an upper chamber and a lower chamber, by a perforated plate 41a, 41b. The perforated plate 41a, 41b permits effluent from the upper chamber to drain into the lower compartment, where the effluent, which contains brine and ice wash, is pumped to the second heat exchanger 32a, 32b for energy recovery and partial cooling of the RFW. The upper chamber is where all the freezing and melting occurs, and the desalinated water obtained therefrom is pumped to the first heat exchanger 31a, 32b for additional energy recovery and the remaining cooling of the RFW.

Each refrigeration unit 50a, 50b, which can also be referred to as a first refrigeration unit 50a and a second refrigeration unit 50b, is coupled to the second tanks 40a, 40b from the desalination units 20a, 20b, respectively. The refrigeration units 50a, 50b are preferably identical water-cooled vapor compression refrigeration devices. Each refrigeration unit 50a, 50b includes an evaporator 51a, 51b to facilitate freezing and a condenser 52a, 52b to facilitate melting. Instead of the evaporator 51a, 51b and the condenser 52a, 52b being disposed in the same upper chamber of the of the corresponding second tank 40a, 40b, the evaporator 51a, 51b and the condenser 52a, 52b are placed in separate second tanks 40a, 40b. This configuration allows the thermodynamic process to occur continuously in tandem, but asynchronously in a normal cycle of operation for the freezing desalination module 10. For example, while the first refrigeration unit 50a is freezing the pre-cooled RFW via the evaporator 51 a in the second tank 40a of the first desalination unit 20, the first refrigeration unit 50a is also melting some of the frozen product in the second tank 40b of the second desalination unit 20b via the condenser 52a. A similar but reverse order operation occurs in the second tank 40b of the second desalination unit 20b during the same time period. Due to the thermodynamic processes involved in the freezing desalination module 10, all the relevant components should be well insulated to minimize thermal losses.

The power to facilitate the above operations is preferably provided by a renewable energy source, such as a photovoltaic (PV) battery 16 coupled to the desalination units 20a, 20b. The freezing desalination module 10 can also be connected to other sources of power, such as a typical outlet powered by the a.c. mains. However, solar energy from the PV battery 16 presents an economic and environmentally friendly solution, especially in arid climates, such as the Middle East, where solar exposure is abundant.

In use, each desalination unit 20a, 20b circulates the RFW through each of the tanks 30a, 30b, 40a, 40b to form ice crystals and utilizes the byproducts thereof to assist in the freezing desalination process. The following description applies to the first desalination unit 20a, with the understanding that the same process occurs in the second desalination unit 20b. The RFW is supplied by the feed line 2 to be collected and pre-cooled in the first tank 20a. The first heat exchanger 31a and the second heat exchanger 31b pre-cool the RFW with the assistance of the cooler desalinated water flowing through the first heat exchanger 31a and the brine/ice wash flowing through the second heat exchanger 31b.

The pre-cooled RFW is then delivered into the upper chamber of the second tank 40a, where the pre-cooled RFW is subjected to freezing from the first refrigeration unit 50a for a period of time. The brine/ice wash is allowed to sieve through the perforated plate 41a and collect in the lower chamber of the second tank 40a. The formed ice crystals are then subjected to melting via the condenser 52b from the second refrigeration unit 50b to render desalinated water. The desalinated water and the brine/ice wash are separately pumped through the respective first heat exchanger 31a and the second heat exchanger 32a to contribute to cooling the RFW. Afterwards, the desalinated water passes through the desalinated line 4 for collection, and the brine/ice wash passes through the brine line 6 for disposal and/or further processing.

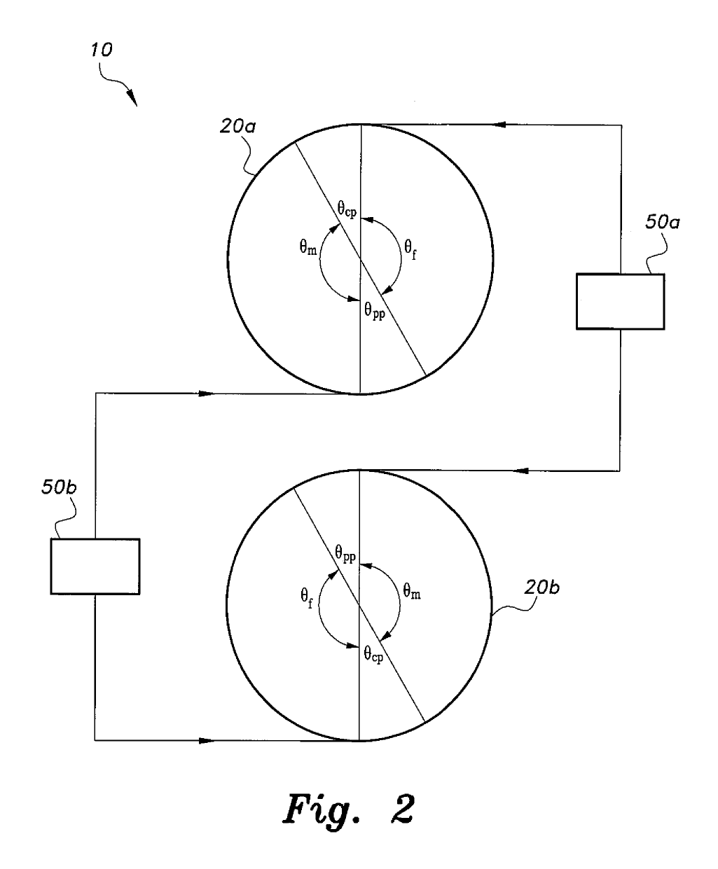

Although each desalination unit 20a, 20b follows the cycle of operation described above, each desalination unit 20a, 20b has been configured to act in tandem at an offset phase from each other, which allows for adjustable timing periods of continuous and discontinuous operation, depending on the workload. An example of such an operation is schematically shown in FIG. 2, where the circles represent a cycle of operation for each desalination unit 20a, 20b.

In a given cyclic period, e.g. an hour, both the first refrigeration unit 50a and the second refrigeration unit 50b are activated. Going clockwise in each circle, the first refrigeration unit 50a freezes pre-cooled RFW in the second tank 40a of the first desalination unit 20a for a freezing period θ_{f} of about 25 minutes. During the same freezing period θ_{f}, the first refrigeration unit 50a performs a melting process in the second tank 40b of the second desalination unit 20b for a melting period θₘ, the melting period θₘ in the second desalination unit 20b being the same length and coincident with the freezing period θ_{f} in the first desalination unit 20a.

A relatively brief partial pre-cooling period θₚₚ of about 5 minutes follows the freezing period θ_{f} in the first desalination unit 20a, where the brine/ice wash is allowed to drain into the lower chamber of the second tank 40a. A coincident and simultaneous pre-cooling completion period θ_{cp} is occurring in the first tank 30b of the second desalination 20b. At the end of the partial pre-cooling period θₚₚ, about 30 minutes remain for charging the first tank 30a with RFW.

After the partial pre-cooling period θₚₚ, the first desalination unit 20a undergoes a melting period θₘ of about 25 minutes via the second refrigeration unit 50b. This coincides with the freezing period θ_{f} occurring in the second desalination unit 20b facilitated by the operation of the second refrigeration unit 50b. During this time, the RFW is being pre-cooled by the combined thermodynamic interactions of the cooler desalinated water flowing through first heat exchanger 31a and the cooler brine/ice wash flowing through the second heat exchanger 32a.

The final step in the cycle of operation of the first desalination unit 20a includes a pre-cooling completion period θ_{cp} of about 5 minutes in which the RFW is cooled to the desired temperature prior to being fed into the connected second tank 40a. This period coincides with the partial pre-cooling period θₚₚ in the second desalination unit 20b.

Thus, it can be seen that greater timing adjustments can be achieved with the freezing desalination module 10. The dedicated first tank 30a, 30b for pre-cooling RFW and second tank 40a, 40b for freezing and melting allows one desalination unit 20a or 20b to perform a freezing desalination process while the other is performing a melting and pre-cooling process. Moreover, the modular nature of the freezing desalination module 10 allows for various mobile constructions or a standalone commercial desalination facility. Furthermore, one or more of the freezing desalination modules 10 can be coupled together to meet various demands.

In various performance analyses of the freezing desalination unit 10, it has been seen that using energy recovery for pre-cooling the sea water feed reduced the required refrigeration capacity by about 24% and reduced the power needed to drive the refrigeration units 50a, 50b by about 82%. During the melting period θₘ in the second tank 40a of the first desalination unit 20a, for example, the heat rejected by the condenser 52b of the second refrigeration unit 50b is about 28% more than that required for the melting process in the second tank 40a. An equalizing heat pump (not shown) can be installed on the second tanks 40a, 40b to remove excess heat.

During one working shift on a sunny day, the freezing desalination module 10 could generate enough fresh water to satisfy the needs of fourteen families in a small village, with a bonus of 6.6 ton refrigeration cooling capacity for air conditioning purposes. Calculations indicated that the freezing desalination module 10 could operate with about 20 kWh/m³ power requirement and specific PV panel surface area requirement of 27 m² per m³/day. The operations of the freezing desalination module 10 can also be fully automated.

It is to be understood that the freezing desalination module 10 encompasses a variety of alternatives. For example, the application for the freezing desalination module 10 is not limited to water desalination facilities. The freezing desalination module 10 and the principles thereof can cover a wide range of industrial needs. It could be used in the food industries, e.g. milk and juice concentration, without harming their nutrition. Also it could be used for concentration adjustment of diluted solutions in pharmaceutical industries. Its application can extend also to the fields of water re-use, produced water, and industrial waste water treatment.

It is to be understood that the present invention is not limited to the embodiments described above, but encompasses any and all embodiments within the scope of the following claims.

We claim:

1. A freezing desalination module, comprising:
a pair of refrigeration units;
a pair of desalination units coupled to the refrigeration units, each of the desalination units producing desalinated water and brine/ice wash from selective freezing and melting of raw feed water by the refrigeration units, each of the desalination units having a first tank for holding and pre-cooling raw feed water and a second tank for freezing and melting the raw feed water;
a feed line coupled to each of the desalination units to feed raw feed water to each of the first tanks;
a desalination line coupled to each of the first tanks to collect desalinated water;
a brine line coupled to each of the first tanks to discharge the brine/ice wash;
a plurality of pumps coupled to the feed lines, the first tanks, and the second tanks to transfer raw feed water, desalinated water, and brine/ice-wash therebetween; and
a power source coupled to the desalination units to provide power for operation of the refrigeration units and the pumps;
wherein each of the desalination units follows the same cycle of operation but out of phase with each other to allow one desalination unit to freeze the raw feed water and form desalinated ice while the other desalination unit melts desalinated ice in the other desalination unit, and vice versa.

2. The freezing desalination module according to claim 1, wherein each of said refrigeration units comprises:
an evaporator disposed inside the second tank of one said desalination unit, the evaporator forming desalinated ice; and
a condenser disposed inside the second tank of the other said desalination unit, the condenser melting ice.

3. The freezing desalination module according to claim 1, wherein each said first tank comprises:
a first heat exchanger coupled to the corresponding second tank and the corresponding desalination line of said first tank's desalination unit, desalinated water from the corresponding second tank flowing through the first heat exchanger to provide a portion of required pre-cooling inside said first tank; and
a second heat exchanger coupled to the corresponding second tank and the corresponding brine line of said first tank's desalination unit, brine/ice wash flowing through the second heat exchanger to provide any remaining pre-cooling required inside said first tank.

4. The freezing desalination module according to claim 1, wherein each said second tank comprises a perforated plate dividing said second tank into an upper chamber and a lower chamber, the perforated plate permitting drainage of brine/ice wash, the upper chamber being coupled to the corresponding refrigeration unit to facilitate freezing and melting therein, the lower chamber collecting brine/ice wash draining through the perforated plate.

5. The freezing desalination module according to claim 1, wherein said plurality of pumps comprises:
a first pump coupled to each said first tank and said feed line, said first pump selectively feeding raw feed water to each said first tank;
a second pump coupled to said first tank and said second tank of each said desalination unit, said second pump transferring pre-cooled raw feed water from said first tank to said second tank of each said desalination unit;
a third pump coupled to said first tank and said second tank of each said desalination unit, the third pump transferring desalinated water from said second tank to said first tank of each said desalination unit; and
a fourth pump coupled to said first tank and said second tank of each said desalination unit, the fourth pump transferring brine/ice wash from said second tank to said first tank of each said desalination unit.

6. The freezing desalination module according to claim 1, wherein said power source comprises a photovoltaic battery.

7. A freezing desalination module, comprising:
a pair of refrigeration units;
a pair of desalination units coupled to the refrigeration units, each of the desalination units producing desalinated water and brine/ice wash from selective freezing and melting of raw feed water by the refrigeration units, each of the desalination units having a pre-cooling tank to hold and pre-cool raw feed water and a freezing tank to freeze and melt the raw feed water;
a feed line coupled to each of the desalination units to feed raw feed water to each of the pre-cooling tanks;
a desalination line coupled to each of the pre-cooling tanks to collect desalinated water;
a brine line coupled to each of the pre-cooling tanks to discharge the brine/ice wash;
a plurality of pumps coupled to the feed line, the pre-cooling tanks, and the freezing tanks to transfer raw feed water, desalinated water, and brine/ice-wash therebetween; and
a power source coupled to the desalination units to provide power for operation of the refrigeration units and the pumps;
wherein each of the desalination units follows the same cycle of operation, but out of phase with each other to allow one of the desalinations unit to freeze the raw feed water and form desalinated ice while the other desalination unit melts desalinated ice and vice versa.

8. The freezing desalination module according to claim 7, wherein each of said refrigeration units comprises:
an evaporator disposed inside the freezing tank of one said desalination unit, the evaporator forming desalinated ice; and
a condenser disposed inside the freezing tank of the other said desalination unit, the condenser melting ice.

9. The freezing desalination module according to claim 7, wherein each said pre-cooling tank comprises:
a first heat exchanger coupled to the corresponding freezing tank and the corresponding desalination line of said pre-cooling tank's desalination unit, desalinated water from the corresponding freezing tank flowing through the first heat exchanger to provide a portion of required pre-cooling inside said pre-cooling tank; and
a second heat exchanger coupled to the corresponding freezing tank and the corresponding brine line of said first tank's desalination unit, brine/ice wash flowing through the second heat exchanger to provide any remaining pre-cooling required inside said pre-cooling tank.

10. The freezing desalination module according to claim 7, wherein each said freezing tank comprises a perforated plate dividing said freezing tank into an upper chamber and a lower chamber, the perforated plate permitting drainage of brine/ice wash; the upper chamber being coupled to said refrigeration units to facilitate freezing and melting therein, the lower chamber collecting brine/ice wash draining through the perforated plate.

11. The freezing desalination module according to claim 7, wherein said plurality of pumps comprises:
a first pump coupled to each said pre-cooling tank and said feed line, said first pump selectively feeding raw feed water to each said pre-cooling tank;
a second pump coupled to said pre-cooling tank and said freezing tank of each said desalination unit, said second pump transferring pre-cooled raw feed water from said pre-cooling tank to said freezing tank of each said desalination unit;
a third pump coupled to said pre-cooling tank and said freezing tank of each said desalination unit, the third pump transferring desalinated water from said freezing tank to said pre-cooling tank of each said desalination unit; and
a fourth pump coupled to said pre-cooling tank and said second tank of each said desalination unit, the fourth pump transferring brine/ice wash from said second tank to said pre-cooling tank of each said desalination unit.

12. The freezing desalination module according to claim 7, wherein said power source comprises a photovoltaic battery.

13. A freezing desalination process, comprising the steps of:
(a) providing a freezing desalination module, having:
a pair of refrigeration units;
a pair of desalination units coupled to the refrigeration units, each of the desalination units producing desalinated water and brine/ice wash from selective freezing and melting of raw feed water by the refrigeration units, each of the desalination units having a first tank for holding and pre-cooling raw feed water and a second tank for freezing and melting the raw feed water;
a feed line coupled to each of the desalination units to feed raw feed water to each of the first tanks;
a desalination line coupled to each of the first tanks to collect desalinated water;
a brine line coupled to each of the first tanks to discharge the brine/ice wash;
a plurality of pumps coupled to the feed line, the first tanks, and the second tanks to transfer raw feed water, desalinated water, and brine/ice-wash therebetween; and
a power source coupled to the desalination units to provide power for operation of the refrigeration units and the pumps;
(b) feeding raw feed water into the first tank of each of the desalination units;
(c) freezing pre-cooled raw feed water in the second tank of one of the desalination units during a first given period of time to form desalinated ice;
(d) melting desalinated ice in the second tank of the other desalination unit during the first given period of time to form desalinated water for collection;
(e) collecting and feeding brine/ice-wash to the first tank of the other desalination unit during the first given period of time to aid in pre-cooling;
(f) partially pre-cooling raw feed water in the first tank of the one desalination unit during a subsequent second given period of time;
(g) completely pre-cooling raw feed water in the first tank of the other desalination unit during the second given period of time;
(h) melting desalinated ice in the second tank of the one desalination unit during a subsequent third given period of time to form desalinated water for collection
(i) collecting and feeding brine/ice-wash to the first tank of the one desalination unit during the third given period of time to aid in pre-cooling;)
(j) freezing pre-cooled raw feed water in the second tank of the other desalination unit during the third given period of time to form desalinated ice;
(k) completely pre-cooling raw feed water in the first tank of the one desalination unit during a subsequent fourth given period of time;
(l) partially pre-cooling raw feed water in the first tank of the other desalination unit during the fourth given period of time; and
repeating steps (b) through (l) until a desired quantity of desalinated water has been produced.

14. The freezing desalination process according to claim 13, further comprising the step of diverting excess cooling to air conditioning systems.
